(19) United States
(12) Patent Application Publication
(10) Pub. No.: US 2004/0239123 A1
(43) Pub. Date: Dec. 2, 2004

(54) Door lock

(76) Inventor: Suk Jin Kim, Dalseong-gun (KR)

Correspondence Address: BIRCH STEWART KOLASCH & BIRCH, PO BOX 747, FALLS CHURCH, VA, 22040-0747, US

(21) Appl. No.: 10/445,840

(22) Filed: May 28, 2003

(51) Int. Cl. E05C 1/12

(52) U.S. Cl. 292/169

(57) ABSTRACT

Disclosed herein is a door lock. The door lock is configured in such a fashion that an indoor-side spindle of a body assembly rotates a retractor using an indoor-side small spindle thereof, in the same manner as an outdoor-side spindle provided with an outdoor-side small spindle. This simplifies a manufacturing process of the indoor-side spindle and enables the outer diameter of the indoor-side spindle to be accurately processed, resulting in the smooth rotation thereof. In addition, respective plate assemblies of the door lock are formed with an operating chamber inside thereof so that rotation springs are installed therein through spring holders, and spring holder covers are fixedly coupled using fixing pieces, along with attachment plates. This configuration simplifies the whole construction and assembly process of the rotation springs.

### BACKGROUND OF THE INVENTION

1. Field of the Invention

The present invention relates to a door lock mainly installed to a door of a commercial building, and more particularly to a door lock which is easy to manufacture and is configured to simplify the whole construction and assembly process thereof.

2. Description of the Related Art

Generally, door locks installed to doors of commercial buildings are classified by grades prescribed in the American National Standards Institute, and should satisfy somewhat severe conditions, for example, high supporting force and torsion strength of a lever. As a representative example of a prior art door lock, reference is made to U.S. Pat. No. 5,809,815.

Considering the prior art door lock, in order to keep an outdoor-side lever in an idle state during a locked state of the door lock, an outdoor-side spindle has a separate small spindle for operating a retractor, whereas an indoor-side spindle is integrally formed with a wing as a component for operating the retractor, instead of the small spindle. This is because manufacturing costs may increase by adding any components to the indoor-side spindle. In addition, rotation springs of the door lock, serving to prevent the return and drooping of levers, are elastically installed within operating chambers, formed at the outer side of plates, using spring holders, and also adapted not to be separated from the operating chambers by coupling spring holder covers thereto using a plurality of fixing pieces. In addition to this spring holder covers, attachment plates are fixedly coupled to the inner side of the plates using a plurality of additional fixing pieces.

According to the prior art door lock, since the indoor-side spindle is integrally formed with the wing for operating the retractor, the indoor-side spindle should be formed using a bending process after the wing is formed. This manufacturing procedure, however, has a problem that the bending process of the indoor-side spindle is complicated due to the wing formed thereon. This hampers the mass production and causes the outer diameter of the indoor-side spindle to be inaccurately processed, thereby deteriorating the smooth rotation of the indoor-side spindle.

Further, in order to install the rotation springs to the plates, the plates should be formed with separate screw holes, in addition to screw holes for coupling the attachment plates. Furthermore, after the rotation springs and spring holders are installed, the spring holder covers should be fixed using a plurality of the fixing pieces. This complicates the whole construction of the rotation springs and adds separate assembly processes, thereby deteriorating the productivity thereof.

### SUMMARY OF THE INVENTION

Therefore, the present invention has been made in view of the above problems, and it is an object of the present invention to provide a door lock configured in such a fashion that an indoor-side spindle has a small spindle in the same manner as the outdoor-side spindle, thereby simplifying a manufacturing process of the indoor-side spindle, and allowing an outer diameter of the indoor-side spindle to be accurately processed, resulting in smooth operation thereof.

It is another object of the present invention to provide a door lock configured in such a fashion that a required installation construction of rotation springs is simplified and thus the whole assembly process thereof is reduced.

In accordance with the present invention, the above and other objects can be accomplished by the provision of a door lock wherein: an indoor-side spindle is formed at the end thereof with coupling grooves, into which projected pieces of an indoor-side small spindle are coupled during insertion of the indoor-side small spindle formed with wings, thereby causing the indoor-side spindle to integrally rotate with the indoor-side small spindle; and

rotation springs are installed inside operating chambers formed at the inner side of plates using spring holders, and then spring holder covers are fixed using fixing pieces, along with attachment plates.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a sectional view illustrating a door lock in accordance with the present invention;

FIG. 2 is an exploded perspective view illustrating the door lock of the present invention; and

FIG. 3 is an exploded perspective view illustrating a body assembly in accordance with the present invention.

### DESCRIPTION OF THE PREFERRED EMBODIMENTS

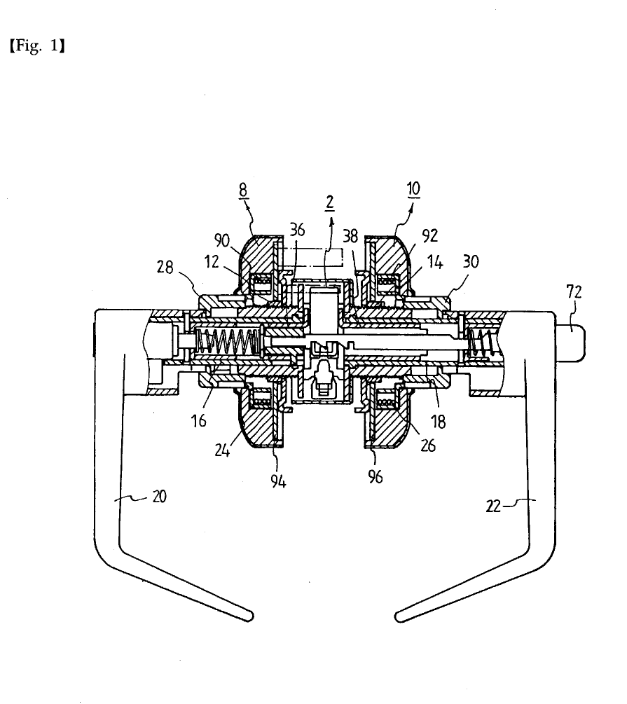

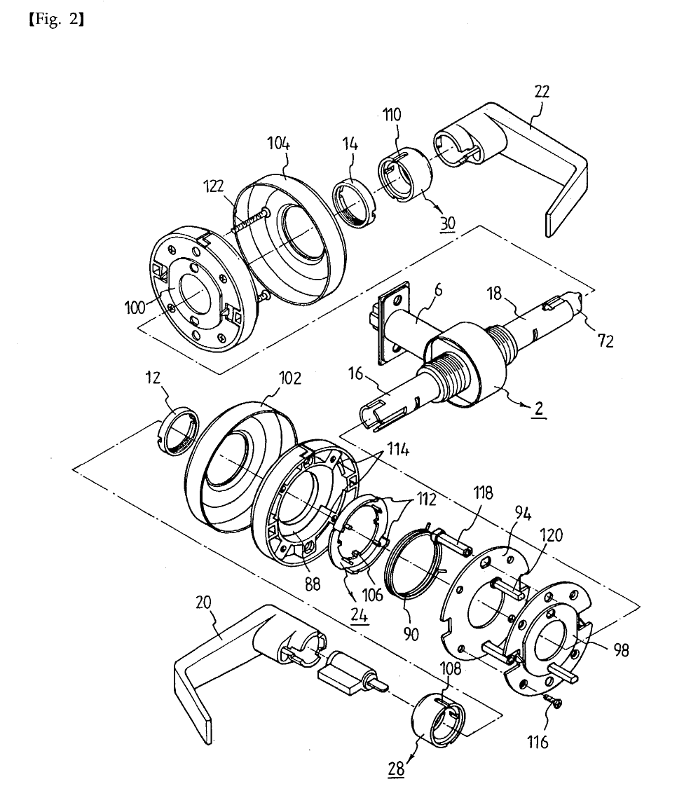

FIGS. 1 and 2 are a sectional view and exploded perspective view illustrating a door lock in accordance with the present invention. As shown in FIGS. 1 and 2, the door lock of the present invention comprises a body assembly 2, a retractor 4 provided in the body assembly 2, a latch assembly 6 connected to the retractor 4, outdoor-side and indoor-side plate assemblies 8 and 10 coupled to the inner and outer sides of the body assembly 2, respectively, nuts 12 and 14 for fixing the respective plate assemblies 8 and 10 to the body assembly 2, outdoor-side and indoor-side spindles 16 and 18, outdoor-side and indoor-side levers 20 and 22 fixedly coupled to the outdoor-side and indoor-side spindles 16 and 18, respectively, outdoor-side and indoor-side spring holders 24 and 26 provided in the outdoor-side and indoor-side plate assemblies 8 and 10, respectively, and outdoor-side and indoor-side plate holders 28 and 30 for connecting the outdoor-side and indoor-side levers 20 and 22 to the outdoor-side and indoor-side spring holders 24 and 26, respectively.

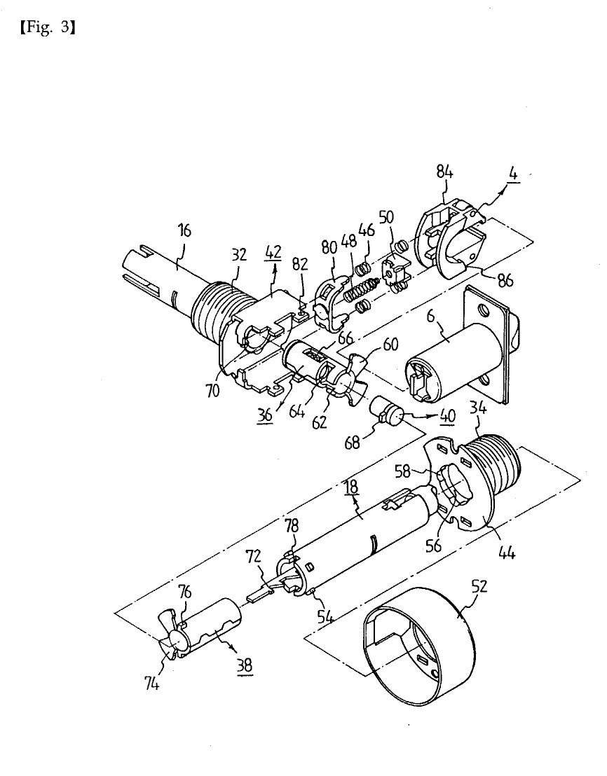

FIG. 3 is an exploded perspective view illustrating the body assembly 2 in accordance with the present invention. As shown in FIG. 3, the body assembly 2 comprises outdoor-side and indoor-side guide pipes 32 and 34, the outdoor-side and indoor-side spindles 16 and 18, a stopper 40, a slide plate 42 and support plate 44, the retractor 4, a saddle 50 and a cap 52. The guide pipes 32 and 34 are formed at their outer surfaces with screw threads, and coupled to the outdoor-side and indoor-side plate assemblies 8 and 10, respectively. The outdoor-side and indoor-side spindles 16 and 18 are rotatably coupled to the outdoor-side and indoor-side guide pipes 32 and 34, and have outdoor-side and indoor-side small spindles 36 and 38, respectively. The outdoor-side small spindle 36 is provided therein with the stopper 40. The slide plate 42 is integrally connected to the outdoor-side guide pipe 32 to face each other, whereas the support plate 44 is integrally connected to the indoor-side guide pipe 34 to face each other. The retractor 4 operates in a sliding manner within the slide plate 42 and is supported by a spring 46. The saddle 50 is slidably installed to the retractor 4 and is supported by a spring 48. The slide plate 42 and support plate 44 are adapted to be inserted into the cap 52.

The guide pipes 32 and 34 are coupled to the spindles 16 and 18, respectively, by coupling a plurality of protrusions 54 formed at the outer peripheral surfaces of the spindles 16 and 18 into respective guide openings 56 circumferentially formed along the whole inner peripheral surfaces of the guide pipes 32 and 34. As the spindles 16 and 18 rotate away from the guide pipes 32 and 34, respectively, the spindles 16 and 18 are separated through respective coupling openings 58 communicating with the guide openings 56.

The outdoor-side small spindle 36 of the outdoor-side spindle 16 is formed at its one end with wings 60 for operating the retractor 4, and at the opposite side of the wings 60 with a coupling slit 62 and an arc-shaped guide groove 64 extended from the coupling slit 62. In addition, the outdoor-side small spindle 36 is provided with a spring 66 in the other end thereof. The spring 66 is supported by a certain support plate.

The stopper 40, inserted in the outdoor-side small spindle 36, has a cylindrical body formed with an outwardly extended holding boss 68. When the stopper 40 is inserted into the outdoor-side small spindle 36, the holding boss 68 is coupled to a coupling groove 70 formed at the outdoor-side spindle 16 through the coupling slit 62, thereby causing the outdoor-side small spindle 36 to rotate along with the outdoor-side spindle 16. When the holding boss 68 recedes and moves inwardly inside the guide groove 64 according to the pushing operation of a locking pawl 72, the outdoor-side lever 20 is in an idle state maintaining the stationary state of the outdoor-side small spindle 36, irregardless of the rotation of the outdoor-side spindle 16.

In the same manner, the indoor-side small spindle 38 of the indoor-side spindle 18 is formed at its one end with wings 74 for operating the retractor 4 and projected pieces 76 near the wings 74. When the indoor-side small spindle 38 is inserted into the indoor-side spindle 18, the projected pieces 76 are coupled into coupling grooves 78 formed at the end of the indoor-side spindle 18, respectively, thereby causing the indoor-side small spindle 38 to rotate along with the indoor-side spindle 18.

The slide plate 42 connected to the outdoor-side guide pipe 32 is formed at its rear side with a holding piece, and at its one lateral side with a plurality of coupling pieces 82. The holding piece is coupled with a spring guide 80, thereby supporting the springs 46 and 48 of the saddle 50 and retractor 4. The plural coupling pieces 82 penetrate perforated holes of the support plate 44 connected to the indoor-side guide pipe 34, thereby allowing pins to be inserted and fixedly assembled through pin holes of the coupling pieces 82.

The retractor 4, adapted to slide along the slide plate 42, is formed at both sides thereof with holding steps 84 and 86. When the holding steps 84 and 86 are engaged with the wings 60 and 74, respectively, formed at the outdoor-side and indoor-side small spindles 36 and 38, the retractor 4 is adapted to move backward, thereby causing the latch assembly 6 to be coupled to the retractor 4 through coupling grooves formed at the front side of the retractor 4.

The saddle 50 is coupled into a guide groove formed at the retractor 4, and adapted to maintain its locked state when it is engaged with the pawl 72 after the pawl 72 is pushed. The saddle 50 moves backward at the same time with the backward movement of the retractor 4, thereby being disengaged from the pawl 72.

Referring again to FIG. 2, the outdoor-side and indoor-side plate assemblies 8 and 10 comprise outdoor-side and indoor-side plates, outdoor-side and indoor-side rotation springs 90 and 92, outdoor-side and indoor-side spring holder covers 94 and 96, outdoor-side and indoor-side attachment plates 98 and 100, and outdoor-side and indoor-side caps 102 and 104. The respective rotation springs 90 and 92 are installed within the inner operating chambers 88 of the plates through the outdoor-side and indoor-side spring holders 24 and 26. The outdoor-side and indoor-side spring holder covers 94 and 96 serve to support the outdoor-side and indoor-side spring holders 24 and 26, respectively.

The respective spring holders 24 and 26 are formed with holding pieces 106 protruded inwardly from the inner edge of their center opening. As the holding pieces 106 are coupled to upper and lower holding grooves 108 and 110 formed at the respective plate holders 28 and 30, the spring holders 24 and 26 are adapted to rotate along with the levers 20 and 22 as well as spindles 16 and 18. The respective rotation springs 90 and 92 are engaged at both ends thereof with the holding steps 112 and 114 formed at the spring holders 24 and 26 and plates, respectively, thereby elastically and bi-directionally supporting the spring holders 24 and 26.

The spring holder covers 94 and 96 are fixed along with the attachment plates 98 and 100 using screws 116. The outdoor-side attachment plate 98 has a screw pipe 118 and a body stopper 120 protruded outwardly from the upper and lower sides thereof. The screw pipe 118 is configured to allow a screw nail 122 to be fastened thereto through a perforated hole of the indoor-side plate. The body stopper 120 is adapted to come into close contact with the upper and lower surfaces of the slide plate 42 provided in the body assembly 2, thereby being integrated with the body assembly 2.

The outdoor-side and indoor-side plate assemblies 8 and 10 are coupled into the outdoor-side and indoor-side guide pipes 32 and 32 of the body assembly 2, respectively, and then fixed by the nuts 12 and 14, adapted to be fastened into the respective guide pipes 32 and 34. After fastening the nuts 12 and 14, the plate assemblies 8 and 10 are coupled with the plate holders 28 and 30 and levers 20 and 22, in turn.

At this time, the holding pieces 106 of the spring holders 24 and 26 are coupled into the upper and lower coupling grooves 108 and 110 of the plate holders 28 and 30, and the ends of the levers 20 and 22 are coupled into coupling grooves formed at respective outer ends of the plate holders 28 and 30, thereby causing the spindles 16 and 18, spring holders 24 and 26, plate holders 28 and 30, and levers 20 and 22 to rotate together.

In the assembled structure as stated above, where the levers 20 and 22 rotate to open a door in an unlocked state, the spindles 16 and 18 rotate along with the small spindles 36 and 38, thereby causing the wings 60 and 74 formed at the small spindles 36 and 38 to engage with the holding steps 84 and 86 of the retractor 4, respectively. As a result, as the retractor 4 moves backward, the latch assembly 6 is pulled, thereby achieving the opening of the door.

In this state, the projected pieces 76 of the indoor-side small spindle 38 are coupled into the coupling grooves 78 formed at the indoor-side spindle 18, thereby causing the indoor-side spindle 18 to rotate with the indoor-side small spindle 38. In the case of the outdoor-side small spindle 36, the holding boss 68 of the stopper 40 inserted inside the outdoor-side small spindle 36 is coupled into the coupling groove 70 formed at the outdoor-side spindle 16 through the coupling slit 62, thereby causing the outdoor-side spindle 16 and small spindle 36 to rotate together.

The levers 20 and 22 are coupled at their ends into the coupling grooves of the plate holders 28 and 30, and the holding pieces 106 of the spring holders 24 and 26 are coupled into the upper and lower holding grooves 108 and 110 of the plate holders 28 and 30. Therefore, the spring holders 24 and 26 rotate at the same time with the rotation of the levers 20 and 22, thereby preventing the return and drooping of the levers 20 and 22 due to the rotation springs 90 and 92.

During locking, the stopper 40 moves backward under the pushing operation of the pawl 72, thereby being inserted deeply inside the outdoor-side small spindle 36. As a result, the holding boss 68 of the stopper 40 moves into the guide groove 64 of the outdoor-side small spindle 36. Therefore, after the door lock is locked, the outdoor-side small spindle 36 maintains its locked state without rotation even if the outdoor-side lever 20 rotates, thereby causing the outdoor-side lever 20 to be in an idle-state.

In order to satisfy the above functions of the door lock, the indoor-side spindle 18 has the indoor-side small spindle 38, which rotates at the same time with the rotation of the indoor-side lever 22 and is adapted to operate the retractor 4 through the wings 74 formed at the indoor-side small spindle 38. This configuration facilitates the manufacture of the indoor-side spindle 18 and enables the accurate processing of the outer diameter thereof, thereby allowing the indoor-side spindle 18 to smoothly rotate in the indoor-side guide pipe 34.

Considering the configuration of the plate assembles 8 and 10, the respective plates thereof are formed therein with the operating chambers 88 for installing the rotation springs 90 and 92 using the spring holders 24 and 26, and the spring holder covers 94 and 96 and attachment plates 98 and 100 are fixed together by the screws 116. Therefore, the installation structure and assembly process of the rotation springs 90 and 92 are simplified.

As apparent from the above description, according to the present invention, the indoor-side spindle 18 of the door lock is configured to operate the retractor 4 through the indoor-side small spindle 38, in the same manner as the outdoor-side spindle 16. This facilitates the manufacture of the indoor-side spindle 18 and enables the accurate processing of the outer diameter thereof, thereby allowing the indoor-side spindle 18 to smoothly rotate. Further, according to the present invention, the rotation springs 90 and 92 provided in the plate assemblies 8 and 10 are installed in the operating chambers 88 formed at the inner side of the plates using the spring holders 24 and 26, and the spring holder covers 94 and 96 and attachment plates 98 and 100 are fixed together by the screws 116. As a result, the construction and assembly process of the rotation springs 90 and 92 can be simplified, thereby increasing the productivity thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. (canceled)

2. A door lock comprising:
a body assembly;
outdoor-side and indoor-side plate assemblies coupled to both sides of the body assembly, respective plates of the plate assemblies defining an operating chamber inside thereof;
outdoor-side and indoor-side spring holders, respectively, coupled with outdoor-side and indoor-side rotation springs, the respective spring holders being inserted and installed within the respective operating chambers; and
outdoor-side and indoor-side spring holder covers fixed at mouths of the respective operating chambers, respectively, along with outdoor-side and indoor-side attachment plates,
wherein the body assembly comprises an indoor-side spindle formed with coupled grooves, into which projected pieces of an indoor-side small spindle is coupled, thereby causing the indoor-side spindle to rotate along with the indoor-side small spindle:

3. A door lock having an indoor-side spindle and an outdoor-side spindle, comprising:
a body assembly, comprising:
an indoor-side hollow spindle having at least one coupling groove;
an indoor-side small-spindle having a diameter that permits it to fit inside of the indoor-side hollow spindle and at least one projection to fit into at least one coupling groove;
whereby the indoor-side hollow spindle is rotatable along with rotation of the indoor-side small spindle.

4. The door lock of claim 3, further comprising:
a stopper having a cylindrical body and an outwardly extended holding boss; and
wherein the indoor small spindle has at least one guide groove to accept the holding boss.

5. The door lock of claim 3, wherein
the indoor-side small spindle has wings adapted to interact with the body assembly.
